(19) United States
(12) Patent Application Publication
(10) Pub. No.: US 2026/0158752 A1
(43) Pub. Date: Jun. 11, 2026

(54) METHOD FOR PRODUCING A ONE-PIECE COMPOSITE STRUCTURE AND BASIN STRUCTURE PRODUCED USING THIS METHOD

(71) Applicant: LATECOERE, Toulouse (FR)

(72) Inventors: Philippe Gail, Brie (FR); Herve Lajous, Saint Suplice Sur Leze (FR)

(73) Assignee: LATECOERE, Toulouse (FR)

(21) Appl. No.: 18/707,915

(22) PCT Filed: Oct. 31, 2022
(86) PCT No.: PCT/EP2022/080389

§ 371 Date: May 7, 2024

(30) Foreign Application Priority Data
Nov. 9, 2021 (FR) FR2111908

(51) Int. Cl. B29C 70/44; B29C 70/38; B29C 70/68; B29L 31/00; B29L 31/30

(52) U.S. Cl. CPC B29C 70/443; B29C 70/382; B29C 70/682; B29L 2031/3076; B29L 2031/724

(57) ABSTRACT

Method for manufacturing a stiffened one-piece composite structure having a panel (2a) and at least one stiffener, which are produced by fiber lay-up, by infusion of resin in an infusion tool (1) that shapes the stiffened structure through the use and incorporates an autonomous heating device realized by inner heating resistors and a covering heating sheet (1i). After placing the infusion tool (1) under vacuum and setting the temperature thereof, the resin is infused into the fibers via the infusion media, prior to demolding of the infused structure followed by trimming.

### CROSS REFERENCE TO RELATED APPLICATION

This application is a National Stage Entry of PCT/EP2022/080389 filed Oct. 31, 2022, under the International Convention and claiming priority over French Patent Application No. FR 2111908 filed Nov. 9, 2021.

### TECHNICAL FIELD

The invention relates to a method for manufacturing a one-piece composite structure by multiple infusion, that is to say infusion initiated simultaneously at different points of the structure. This infusion forms part of what are known as Out Of Autoclave, hereinafter denoted OOA, solutions for manufacturing composite materials. These solutions have the notable feature of no longer using a high-pressure autoclave which is conventionally utilized in the manufacture of composite structure components. The invention also relates to a stiffened door structure in the form of a basin, produced using this manufacturing method. Notably the doors of vehicles-aircraft, trains, ships-and of buildings are intended to be able to be manufactured according to this method.

In the aeronautical sector in particular, the doors of an aircraft allow people and goods to enter and exit the cabin of the aircraft. These doors are subject to numerous constraints and they are fitted with numerous items of equipment: their complex structure requires a specific manufacturing process.

### PRIOR ART

An aircraft door is manufactured by assembly of numerous separate components in order to meet the requirements of its complex structure. Specifically, such a door is incorporated into the fuselage and creates an interface between the interior of the aircraft, the cabin, and the external environment. During the flight of such an aircraft, the difference in pressure between the cabin and the external environment remains high, subjecting the door to numerous constraints. An aircraft door is also fitted with items of equipment such as opening and locking mechanisms, safety devices and other items of equipment which are fastened to the door. In order to meet these requirements, the structure of such a door is generally constituted from a panel machined and/or shaped to the dimensions of the door frame, this panel being stiffened with stiffeners attached and assembled with the aid of mechanical fasteners.

Traditionally, the panels and the stiffeners are in metal: metals have mechanical properties that impart robustness to the elements of the door allowing it to fulfill its role of interior-exterior interface and to support the weight of the items of equipment. The conventional techniques for machining and shaping the metals in the aeronautical sector include checks and monitoring of the quality of the components produced in order to ensure the assembly of a door in accordance with the applicable standards. However, these metal doors are heavy and require a significant assembling and installation time: they do not correspond to the development of new aircraft with reduced mass. In addition, the assembly of multiple components, in particular by way of rivets, creates local force concentration sites that may result in static fractures or in crack propagation in these components: a maintenance program for the aircraft door is thus established to periodically inspect these force concentration sites.

Furthermore, patent document US2009078826A1 discloses a conventional aircraft door, the panels and the stiffeners of which are made of fiber composite. Each of these structure components is manufactured individually according to a method of depositing fibers followed by resin transfer molding. These fiber composite doors are more lightweight than their metal equivalents. However, the mounting and installation times are still substantial.

In order to reduce the use of assembly rivets and to provide greater intervals of inspection in the maintenance program, patent document US2004021038A1 discloses a metal door, the panels and the stiffeners of which are machined in a single piece. However, the mass of such a door remains close to that of a conventional door.

### SUMMARY OF THE INVENTION

In order to remedy the drawbacks of the prior art that are set out above, the main objective of the invention is to improve the mounting of a structure such as an aircraft door and to increase the interval between two inspections in the maintenance program.

To this end, the invention provides for a composite aircraft door with a lower mass than a metal door to be produced by combining lay-up of fibers with multiple resin infusion of the OOA type. In addition, this door structure is in one piece, that is to say that the entire structure constitutes only a single piece. This one-piece door has a reduced mass and is therefore easier to manipulate. In addition, this mass saving contributes to the overall optimization of the mass of the aircraft.

More precisely, the subject of the present invention is a method for manufacturing a stiffened one-piece composite structure, this structure comprising a panel and at least one stiffener. The manufacture is carried out according to the following steps:
fiber lay-up of the panel and of preforms of the stiffeners;
introduction of the panel and of the preforms into an infusion tool incorporating an autonomous heating mean;
introduction of shaping plates and of bladders;
introduction of infusion media;
incorporation of infusion pipes into the bladders;
introduction of a covering heating sheet for covering the structure, comprising at least one vent;
placing the infusion tool under vacuum and setting the temperature thereof;
infusion of the resin into the fibers via the infusion media, and
demolding of the infused structure followed by trimming.

Advantageously, using a panel and preforms makes it possible to adjust the dimensions of the stiffened structure and to adapt the configuration of the structure.

Also advantageously, the infusion tool enables multiple resin infusion thus dispensing with the traditional use of an oven which heats the entire chamber. The infusion tool has dimensions of the same order of magnitude as the structure to be manufactured. The temperature conditions are localized solely on the component to be infused by virtue of the autonomous heating means which is realized by the surfaces of the mold in contact with the fibrous preform and by the covering sheet. In addition, since the heating means is close to the panel and the preforms, the energy consumption is optimized.

In addition, the infusion of the resin makes it possible to assemble all of the preforms in a single step and to obtain a stiffened one-piece structure. Specifically, the preforms obtained by fiber lay-up are juxtaposed according to the geometry of the structure to be produced, the stiffeners being positioned on any type of panel, in particular a panel of complex shape, and then the resin is infused from the panel to the stiffeners. As it solidifies, the resin produces joints between the different preforms, forming a one-piece structure.

In certain preferred forms of implementation:
in the lay-up step, the panel and the preforms are produced according to what is known as an automated fiber placement (AFP) method;
the preforms are planar in the lay-up step and then subsequently subjected to a step of shaping by hot forming;
the step of shaping the preforms is carried out with a deformable sheet and a vacuum-drawing system;
after the lay-up step, a step of forming the structure comprising the panel is carried out in accordance with a desired structure geometry;
the infusion media are introduced on the panel, with the resin infusing from the panel to the stiffeners;
the heating sheet and the bladders are made of reusable material with high deformability, in particular made of silicone;
a step of carrying out a vacuum test prior to infusion of the resin;
a cooling step prior to the demolding of the structure.

Advantageously, AFP lay-up is compatible with the manufacture of panels of complex shape, in particular having curvatures and/or decreasing peripheral frames, and with the manufacture of stiffener preforms that do not require any further shaping, in particular having a C-shaped and/or U-shaped section.

Also advantageously, the preforms and the panel are shaped by forming to produce the architecture of the structure before being impregnated with resin. The preforms may therefore have simple geometries which are then shaped during the forming so as to obtain a structure of complex shape, thus simplifying their creation. An outer flange may also be produced on a peripheral frame of the panel in order to facilitate the installation of the structure.

The invention also relates to a stiffened one-piece structure of an aircraft door, produced by the method above. This structure comprises a panel and at least one stiffener each resulting from an independent lay-up of composite fibers. The stiffeners comprise an inner flange, a web and an outer flange that originate from preforms. More particularly, the panel comprises a peripheral frame, the panel and its frame forming a basin. By infusion of resin into the fibers, the basin and the stiffeners are then assembled such that the door has a one-piece structure.

Advantageously, such a one-piece door makes it possible to avoid customary assembly problems for door structure components, in particular the alignment of these components. In addition, by assembling a composite structure in this way without any drilling or additional fastening elements, the structural integrity is improved while having a weight saving. Specifically, the drilling zones and fastening elements in a base structure are force concentration zones and therefore subject to damage that may lead to the fracture of the structure.

Also advantageously, the structure is not manufactured directly in one piece but from preforms of simpler design which are then shaped. These preforms afford the possibility of varying the dimensions of the stiffeners in particular to locally reinforce the door and/or locally make it lighter.

According to preferred embodiments:
this peripheral frame has a frame outer flange at a free end edge, and the panel has a pierced opening in order to install a window.

### BRIEF DESCRIPTION OF THE FIGURES

Other features and advantages of the present invention will become apparent from the following reading of a detailed exemplary embodiment without limiting the scope of said invention, with reference to the appended drawings in which, respectively:

FIG. 1 shows an exploded perspective view of an autonomous infusion tool and of an aircraft passenger door structure according to the invention;

FIG. 2 shows a perspective view of the infusion tool after installation of the basin and of the stiffeners according to the method of the invention;

FIG. 3 shows a perspective view of the infusion tool after installation of the stiffener outer flanges according to the method of the invention;

FIG. 4 shows a perspective view of the infusion tool after installation of the outer flange shaping plates according to the method of the invention;

FIG. 5 shows a perspective view of the infusion tool after installation of the bladders according to the method of the invention;

FIG. 6 shows a perspective view of the infusion tool after installation of the heating sheet according to the method of the invention;

FIG. 7 shows the stiffened one-piece door structure obtained after demolding, and

FIG. 8 shows the stiffened one-piece door structure after machining.

### DETAILED DESCRIPTION OF THE INVENTION

In the figures, identical reference signs refer to the same element and to the corresponding passages of the description.

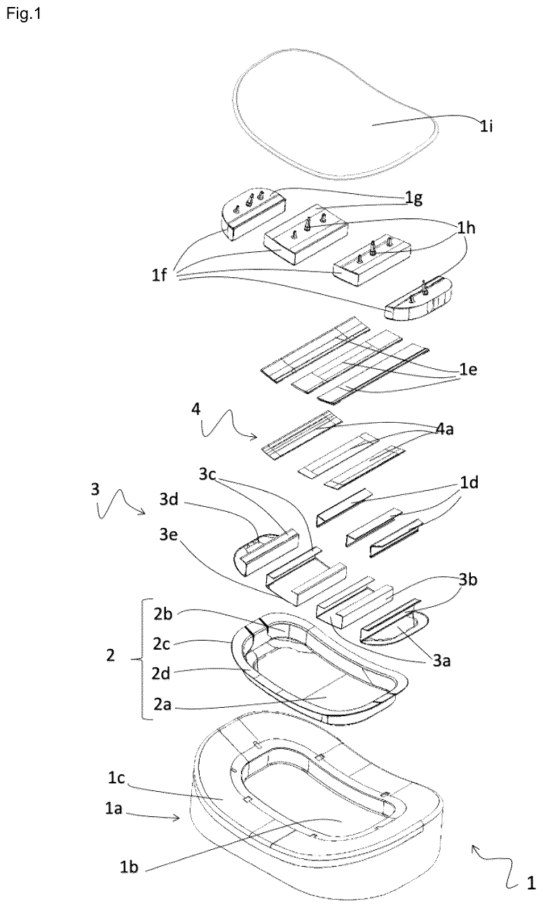

FIG. 1 shows an exploded perspective view of the infusion tool 1, and also of the door structure 2 in the form of a basin and of the stiffener preforms 3, 4. The tool 1 effects autonomous infusion of resin into the fibers of the preforms 3, 4 and of the basin 2, enabling the shaping of a stiffened one-piece composite structure.

The first manufacturing step consists in carrying out fiber lay-up of the panel 2a and of the planar preforms 3, 4 of the stiffeners. This lay-up is performed according to an automated fiber placement (AFP) method. In this exemplary embodiment, the base panel 2a is an integral part of the basin 2 and forms the bottom thereof. The automation of the lay-up of the basin 2 allows it to be optimized so as to notably comply with the stacking of the fibers and their orientation over its entire extent.

In addition to the panel 2a as bottom, the basin 2 comprises a peripheral frame 2b as upright edge rising up from the perimeter of the panel 2a. Advantageously, a step of forming the basin 2 is also implemented so as to produce a frame outer flange 2c on the upright edge of the basin 2. To this end, a bladder under vacuum folds, on a mold, the end of the upright edge of the basin so as to form the frame outer flange 2c of the basin. This outer flange extends over the entire edge of the basin 2 and thus forms a bearing face 2d for the stiffeners. As an alternative, the frame outer flange 2c of the basin 2 may be formed only on certain zones of the edge of the basin 2.

The, in this case three, stiffeners conventionally comprise a web extended orthogonally, at one of its longitudinal edges, by an inner flange ensuring the connection to the panel 2a, and, at its other longitudinal edge, by an outer flange. The preforms of the stiffeners thus make it possible to obtain this structure of web, inner flange and outer flange. In this exemplary embodiment, the inner flange 3a and the outer flange 3c extend on either side of the web 3b.

Each stiffener is manufactured by infusion of resin into three preforms: two preforms 3, referred to as lower preforms, having a C-shaped section that are abutted by the web so as to each form an inner flange 3a, a web 3b and an outer flange support 3c, the inner flange 3a ensuring a double connection to the panel 2a on either side of the web 3b; the third preform 4, referred to as upper preform, is planar and forms the outer flange 4a. In order to reduce the number of preforms, two facing C-shaped preforms, belonging to two consecutive stiffeners, may be combined into a single piece and have a common inner flange: the resultant preform then having a U-shaped section. In this preferred embodiment, the preforms referred to as extreme preforms 3d have a C-shaped section and the preforms referred to as intermediate preforms 3e have a U-shaped section. In other embodiments, the C-shaped sections may be kept in the non-combined state to produce intermediate preforms. Preform variants are also possible in order to produce stiffeners in which the inner flange and/or the outer flange extend/extends only on one side of the web.

During their lay-up, the preforms 3, 4 of the stiffeners are planar: hot forming of the lower preforms 3 is then carried out with a deformable sheet and a vacuum-drawing system in order to obtain the C-shaped and U-shaped sections. The upper preforms 4 which correspond to the outer flanges remain planar and therefore do not require any forming by bending in this exemplary embodiment. In other embodiments, the upper preforms 4 are subjected to a forming operation so as to also provide material to the web of the stiffeners.

After forming of the lower preforms 3, the latter are introduced, together with the basin 2, into the infusion tool 1 incorporating an autonomous heating means. This tool 1 comprises a mold 1a in which the basin 2 is installed, the panel 2a of the basin being in contact with the bottom 1b of the mold 1a and the outer flange 1c of this basin resting on an upper face 1c of the mold 1a. The architecture of the structure is obtained by the introduction of shaping plates 1d, 1e and of bladders 1f. These shaping plates 1d, 1e contribute to the structure by keeping the preforms 3, 4 in position prior to and during the infusion. The bladders 1f are installed in the lower preforms 3.

Two types of shaping plates 1d, 1e are used in this exemplary embodiment. A first type of plate 1d in the form of an angle iron, in this case made of composite material, is placed under each outer flange support 3c of the lower preforms 3. They control the angle between the outer flange and the web of the stiffeners and provide a rigid support for the bladders 1f. The second type 1e of shaping plates is planar and covers each outer flange 4a. The bladders 1f, in this case made of silicone, occupy the rest of the space between the lower preforms 3.

Infusion media on the panel 2a of the basin 2 are also introduced: they allow the resin to infuse into the panel 2a from the vicinity of each infusion medium. These infusion media are supplied by infusion pipes 1h incorporated into the bladders 1f.

A covering heating sheet 1i closes the mold 1a of the infusion tool 1. The autonomous heating means of the infusion tool is realized, for the one part, by heating resistors located in the mold 1a in the vicinity of the basin 2 and in the shaping plates 1d, and, for the other part, by the covering heating sheet 1i. This autonomous heating means allows the resin to be brought to and maintained at the desired temperatures. In another embodiment, heating resistors are also installed in the bladders 1f, said resistors then also contributing to the heating and to the maintenance of the temperature.

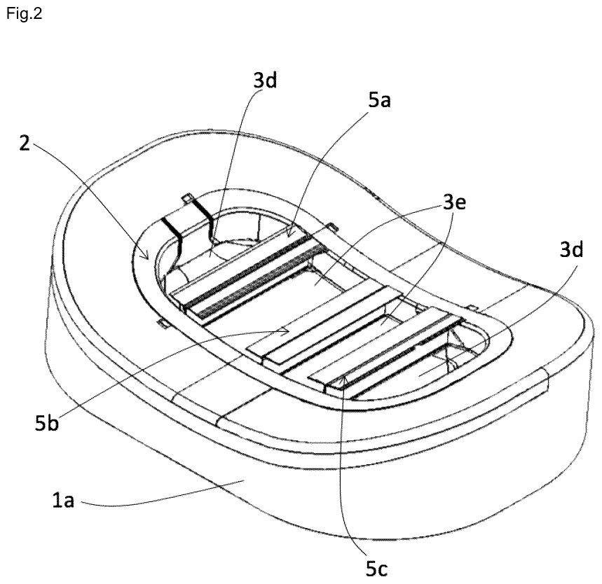

FIG. 2 shows the mold 1a of the infusion tool 1 with the basin 2 and the lower stiffener preforms 3 constituting a total of three stiffeners 5a, 5b, 5c. The extreme stiffeners 5a, 5c are molded from the juxtaposition of two lower preforms 3d, 3e having a C-shaped and U-shaped section, respectively, and the intermediate stiffener is formed by two lower preforms 3e having a U-shaped section.

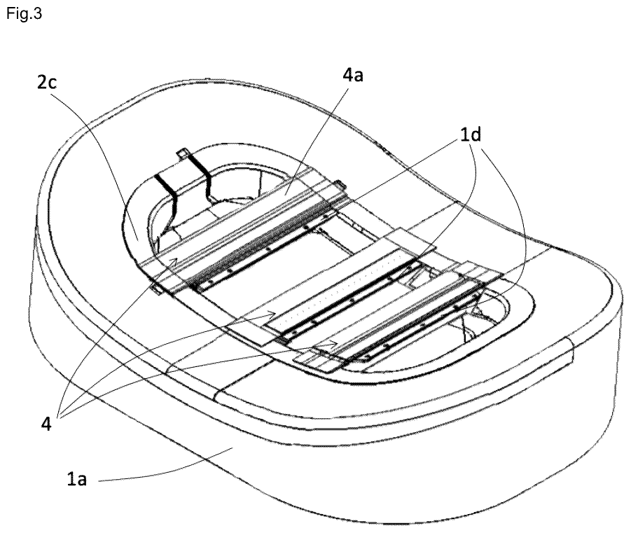

In FIG. 3, the upper stiffener preforms 4 forming the outer flanges 4a are introduced and cover the outer flange supports 3c of the lower preforms 3. The angle-iron-shaped shaping plates 1d are also installed so as to shape the connection between the upper preforms 4 and the lower preforms 3. These upper preforms 4 are also in contact with the frame outer flange 2c of the basin 2, the infusion of the resin subsequently allowing the stiffener outer flanges 4a to be connected to the basin 2.

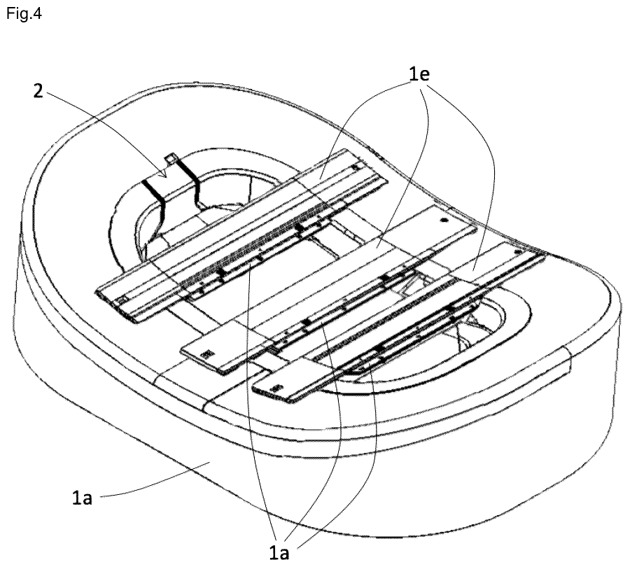

With reference to FIG. 4, the installation of the planar shaping plates 1e which cover the outer flanges 4a is illustrated: these planar shaping plates 1e extend beyond the basin 2 so as to be fastened to the mold 1a.

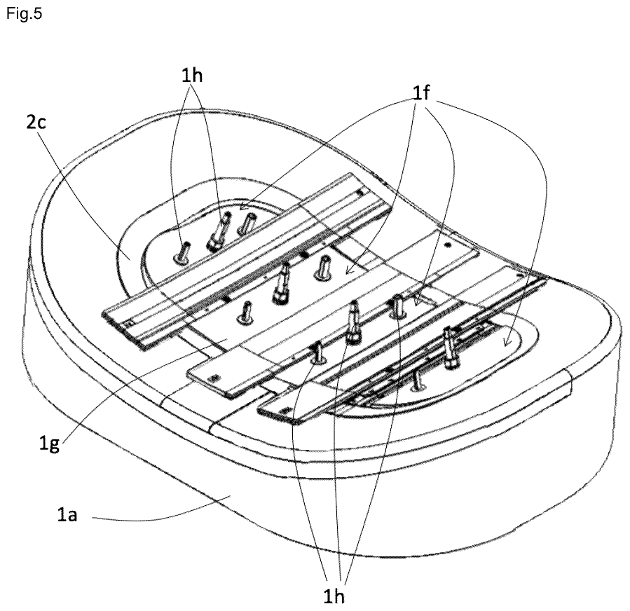

FIG. 5 shows the infusion tool with four bladders 1f positioned in the stiffener preforms 3, 4. These bladders 1f, due to the malleable nature of their material, occupy the free space of the stiffener preforms 3, 4 and are dimensioned such that their upper face 1g forms a continuous surface with the frame outer flange 2c of the basin 2 and with the upper surface 1c of the mold 1a of the infusion tool 1. They also comprise the infusion pipes 1h that allow the resin to pass through the bladders 1f in order to reach the bottom of the basin and infuse into the panel 2a.

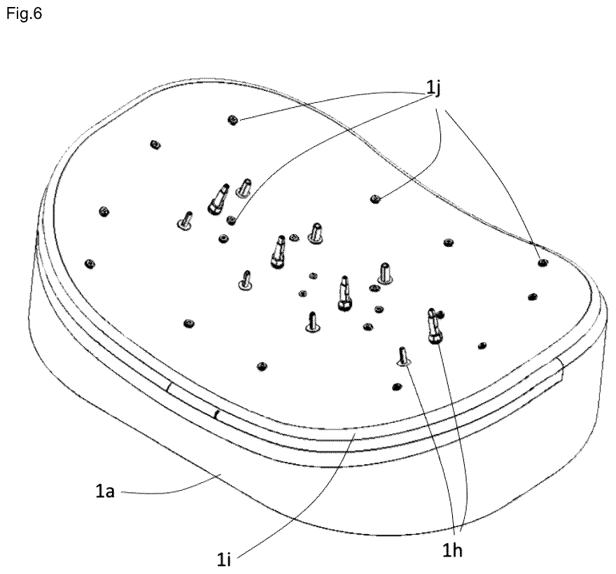

In FIG. 6, a covering heating sheet 1i comprising approximately twenty vents 1j completely covers the basin 2 and the stiffener preforms 3, 4. The covering heating sheet 1i and the bladders 1f, which are made of reusable material with high deformability -in this case silicone-, increase and maintain the temperature of the resin at a predetermined value, thus enabling its infusion under a controlled temperature of about 120° C. This infusion is brought about by the infusion tool 1 being placed under vacuum by way of the vents 1j in connection with a pump (not shown). The autonomous heating means also makes it possible to increase the temperature to around 180° C. in order to cure and polymerize the resin. An optional step of a vacuum test is carried out after the placing under vacuum in order to verify that said vacuum has been produced and is tight.

The resin is then infused via the infusion pipes 1h and then the infusion media on the panel 2a of the basin 2. This resin infuses into the fibers from the panel 2a to the stiffener preforms 3, 4 until it reaches the vents 1j in the covering heating sheet 1i, this infusion being made easier by the placing under vacuum of the infusion tool 1 combined with the heating of the bladders 1f and of the covering heating sheet 1i. The vents 1j are preferably arranged strategically so as to ensure that the resin infuses into the entire composite structure in order to form a one-piece structure. These vents 1j are arranged at the periphery of the frame 2b of the basin 2 on the upper surface 1c of the mold 1a such that the resin infuses into the entire basin 2. Other vents are arranged on the upper shaping plates 1e and in the bladders 1f such that the resin infuses into the stiffener preforms. The resin therefore infuses from the panel 2a to the stiffeners, thus producing connections between the different fiber lay-ups. When the resin exits in a fluid and bubble-free manner from all of the vents, the infusion is considered to have been correctly carried out. A verification of the state of the infusion is carried out by quantifying the quantity of resin which has been infused.

After cooling, the resin solidifies, in particular at the contact zones between the panel 2a and the lower preforms 3 of the stiffeners and at the stiffener outer flanges 4a, thus creating connections and assembling a one-piece structure. After cooling, the infused one-piece structure is then demolded and trimmed in order to remove excess resin and adjust the shape of the aircraft door as provided.

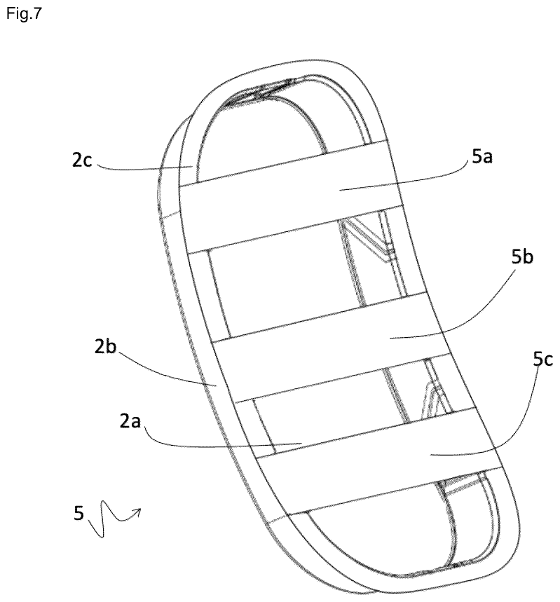

FIG. 7 illustrates a stiffened one-piece structure of an aircraft door 5, manufactured by the method described above. This structure comprises a panel 2a and three stiffeners 5a, 5b, 5c each resulting from an independent lay-up of composite fibers. The stiffeners comprise, as described above (cf. FIG. 1), an inner flange, a web and an outer flange 4a that originate from planar preforms subjected to a forming operation. The panel additionally comprises a peripheral frame 2b, in order to form a structure of a basin 2. By infusion of resin into the fibers, the basin 2 and the stiffeners 5a, 5b, 5c are then assembled such that the resultant door 5 has a one-piece structure.

The peripheral frame 2b of the basin 2 has, at its free end, a basin frame outer flange 2c, produced in this case by forming. The other, non-free end of the peripheral frame 2b is secured to the panel 2a of the door. This basin outer flange may alternatively be formed during the lay-up of the basin or during the infusion through the use of additional outer flange preforms.

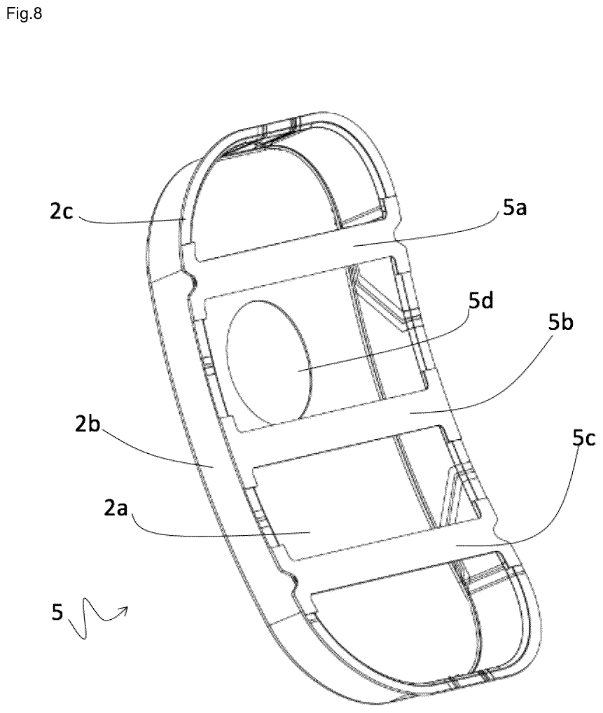

FIG. 8 shows the one-piece door 5 machined so as to be adapted to its use. In particular, the panel 2a is pierced to form an opening in order to install a window 5d, and the stiffeners 5a, 5b, 5c and the basin frame outer flange 2c of the peripheral frame 2b are refined by removal of the excess resin and excess fibers.

The invention is not limited to the exemplary embodiments and implementations described and shown. Thus, the lay-up of the panel and of the preforms may be carried out manually. In addition, other means for hot forming the preforms may be used, such as bending or mold-against-mold hot forming.

In addition, the infusion media are positioned in this case on the panel and the vents on the heating sheet, inducing an infusion of the resin from the panel to the stiffeners: infusion from the stiffeners to the panel is conceivable by positioning the infusion media on the stiffeners and suitable vents connected to the panel.

Other reusable materials with high deformability such as latex and rubber may also be used for the bladders and the covering heating sheet.

Furthermore, the autonomous heating means may combine several heating members. In the exemplary embodiment, the mold of the tool and the shaping plates comprise heating resistors. In another embodiment, the bladders also comprise heating resistors. These two modes of heating may be combined with one another and with other heating members.

1. A method for manufacturing a stiffened one-piece composite structure, the composite structure having a panel (2a) and at least one stiffener, wherein the method comprises the following steps:
fiber lay-up of the panel (2a) and of preforms of the stiffeners;
introducing the panel (2a) and of preforms (3, 4) into an infusion tool (1) having an autonomous heating device;
introducing shaping plates (1d, 1e) and bladders (1f);
introducing an infusion media;
incorporating infusion pipes (1h) into the bladders (1f);
introducing a covering heating sheet (1i) to cover the structure, the covering heating sheet comprising at least one vent (1j);
placing the infusion tool (1) under vacuum and setting a temperature;
infusing a resin into the fibers via the infusion media, and demolding of the infused structure followed by trimming.

2. The manufacturing method as claimed in claim 1, wherein, in the lay-up step, the panel (2a), and the preforms (3, 4) are produced by an automated fiber placement (AFP) method.

3. The manufacturing method as claimed in claim 1, wherein the preforms are planar in the lay-up step and then subsequently subjected to a step of shaping by hot forming.

4. The manufacturing method as claimed in claim 3, wherein the step of forming the preforms is carried out with a deformable sheet and a vacuum-drawing system.

5. The manufacturing method as claimed in claim 1, wherein, after the lay-up step, a step of forming the structure comprising the panel (2a) is carried out in accordance with a desired structure geometry.

6. The manufacturing method as claimed in claim 1, wherein the infusion media are introduced on the panel.

7. The manufacturing method as claimed in claim 1, wherein the covering heating sheet (1i) and the bladders (1f) are made of reusable material with high deformability, in particular made of silicone.

8. The manufacturing method as claimed in claim 1, wherein a vacuum test in the infusion tool (1) is carried out prior to the infusion of the resin.

9. The manufacturing method as claimed in claim 1, wherein the infusion tool (1) is cooled prior to the demolding of the structure.

10. A of an aircraft door (5), produced using the method as claimed in claims 1, the stiffened one-piece structure comprising:
a panel (2a) and at least one stiffener (5a, 5b, 5c) each resulting from an independent lay-up of fibers, the stiffeners (5a, 5b, 5c) comprising an inner flange, a web and an outer flange that originate from preforms, wherein the panel (2a) comprises a peripheral frame (2b) forming with the panel a basin (2) which is assembled with the stiffeners (5a, 5b, 5c) by infusion of resin into their fibers.

11. The stiffened one-piece structure as claimed in claim 10, wherein the peripheral frame (2b) has a frame outer flange (2c) at a free end edge.

12. The stiffened one-piece structure as claimed in claim 10, wherein the panel (2a) has a pierced opening (5d).
